(19) United States
(12) Patent Application Publication
(10) Pub. No.: US 2023/0221433 A1
(43) Pub. Date: Jul. 13, 2023

(54) SYSTEM AND A METHOD FOR DETERMINING POSITIONS OF SENSOR UNITS

(71) Applicant: Freedrum Studio AB, Malmo (SE)

(72) Inventors: Peter Andersson, Malmo (SE); Philip Robertson, Malmo (SE); George Charkviani, Malmo (SE); Pablo Costas Franco, Malmo (SE)

(21) Appl. No.: 17/574,468

(22) Filed: Jan. 12, 2022

(51) Int. Cl. G01S 15/86; G01S 15/06; G01S 7/52; G01S 7/526

(52) U.S. Cl. CPC G01S 15/86; G01S 15/06; G01S 7/52004; G01S 7/526

(57) ABSTRACT

A system (1) is provided. The system comprises two primary sensor units (10) and two secondary sensor units (20). The secondary sensor units are configured to receive ultrasonic pulses during time windows, wherein a time window of the time windows comprises a corresponding transmit time of predetermined transmit times. The system is configured to determine a time-of-flight of an ultrasonic pulse of the ultrasonic pulses transmitted at a transmit time of the transmit times based on when the ultrasonic pulse was received during the corresponding time window. The system is further configured to determine a distance between two of the sensor units based on the determined time-of-flight between said sensor units. The system is configured to determine the positions of the sensor units in real-time based on measured movements and the determined distances.

### TECHNICAL FIELD

The present disclosure relates generally to the field of position determination.

More specifically it relates to determining positions of sensor units.

### BACKGROUND

The interest in virtual reality, VR, and augmented reality, AR, has been steadily increasing. One contributor to the increase is the increased capabilities of tracking objects in space, which have allowed for user's to interact with virtual, or augmented, objects in space. Tracking of objects in space may be of interest within fields such as gaming, playing virtual instruments, or virtual, or augmented, reality crafts, sports or skills.

An example tracking objects in space is within video games, where movement of a user may be tracked by a camera, or by tracking objects held by the user. Such solutions rely on fixedly mounted devices which are able to track the user or the object held by the user. In other words, the tracking relies on at least one fixed reference point. Another limitation of such solutions is that they only allow for tracking at the site where they are installed.

Solutions exist for tracking the movements of a user by utilizing inertia measurement units, IMUs, to track the movement of an object held by, or fixed to, a user. However, IMUs experience noise and drift, and their precision is therefore limited.

### SUMMARY

It is therefore an object of the present disclosure to overcome at least some of the above-mentioned drawbacks, and to provide an improved system for determining positions sensor units. The improved system provides an increased precision and allows for tracking sensor units without a fixed reference point.

According to an aspect of the present disclosure, a system provided. The system comprises two primary sensor units and two secondary sensor units. Each sensor unit comprises an inertial measurement unit, IMU, configured to measure movement of the sensor unit. The primary sensor units and a first sensor unit of the secondary sensor units are configured to transmit ultrasonic pulses at predetermined transmit times. The secondary sensor units are configured to receive the ultrasonic pulses during time windows. A time window of the time windows comprises a corresponding transmit time of the predetermined transmit times. The system is configured to determine a time-of-flight of an ultrasonic pulse of the ultrasonic pulses transmitted at a transmit time of the predetermined transmit times based on when the ultrasonic pulse was received during the corresponding time window. The system is further configured to determine a distance between two sensor units based on the determined time-of-flight. Correspondingly, the system is further configured to determine distances between the secondary sensor units, and between the secondary sensor units and the primary sensor units, based on the determined time-of-flights between said sensor units. The system is configured to determine the positions of the sensor units in real-time based on the measured movements and the determined distances.

According to a second aspect of the present disclosure, a method for determining positions of sensor units of a system is provided. The system comprises two primary sensor units and two secondary sensor units. Each of the sensor units comprises an inertial measurement unit, IMU, configured to measure movement of the sensor unit. The method comprises the steps of:
transmitting ultrasonic pulses at predetermined transmit times from a primary sensor unit of the primary sensor units and a first sensor unit of the secondary sensor units,
receiving the ultrasonic pulses by the secondary sensor units during time windows, wherein a time window of the time windows comprises a corresponding transmit time of the predetermined transmit times,
determining a time-of-flight of an ultrasonic pulse transmitted at a transmit time based on when the ultrasonic pulse was received during the corresponding time window,
determining the positions of the sensor units in real-time based on the measured movements and the determined distances.

The IMUs may be configured to measure translational and rotational movement of its corresponding sensor unit. The IMUs may comprise an accelerometer and/or a gyroscope. A gyroscope often suffer from DC level bias, which may reduce the precision of readings of the gyroscope. Thus, the readings, i.e. raw data, of a gyroscope of an IMU may be filtered via a filter, which may be a high frequency filter. Correspondingly, readings, i.e. raw data, of an accelerometer of an IMU may be filtered through a filter, such as a glitch filter. Thus, abnormal readings, such as peaks, may be avoided or reduced.

A time window may be understood as a time period during which one or more secondary sensor units are recording in order to record an ultrasonic pulse. By only recording during the time periods, rather than all of the time, the amount of recorded, or gathered, data is greatly reduced, which increases the efficiency of the system. Increasing the efficiency of the system may allocate more computational resource for the system, which may ultimately allow for a more precise determination of the positions of the sensor units.

By the term “a transmit time”, it is meant, for example, a defined time, or predetermined time, of transmission of an ultrasonic pulse. In other words, “a transmit time of an ultrasonic pulse” may be understood as the point in time when an ultrasonic pulse is transmitted. A transmit time may be known by the sensor unit transmitting an ultrasonic pulse and the sensor unit(s) receiving, due to ultrasonic recording, the ultrasonic pulse. Thus, the sensor unit(s) which is receiving, and is thereby recording during a corresponding time window, may know when to expect to receive the ultrasonic pulse. Consequently, determining a time-of-flight of an ultrasonic pulse based on when the ultrasonic pulse was received may be determined by comparing the time when the ultrasonic pulse was received with the transmit time of the ultrasonic pulse.

Determining the distances between sensor units based on the determined time-of-flights may be determined by multiplying the time-of-flight with the speed of sound.

The system may be configured to determine the positions of the sensor units in real-time by combining the measured movements and the determined distances. In other words, the system may be configured to determine the positions of the sensor units by using the measured movements of the sensor units and the determined distances between sensor units. By using both the determined distances and the measured movements, the precision of the determined positions may be increase in comparison to only using one of the measured movements and the determined distances. The determined distances may be utilized to improve the precision of the measured movements, and correspondingly the measured movements may be utilized to improve the precision of the determined distances.

By the term “in real-time”, it may be meant, for example, continuously and/or with a minor delay, wherein the minor delay may be less than 10 ms.

The first sensor units may be configured to be held in a user's hands and wherein the second sensor units are configured to be mounted on the user's feet.

The primary sensor units may be understood as, for example, sensor units which may be held in the hands of a user, or worn on, or be configured to be attached to, the hands of a user. For example, the primary sensor units may be configured as sticks, such as drum sticks, which may be held in the hands of a user. Hence, the primary sensor units may alternatively be referenced to as, for example, hand sensor units.

The secondary sensor units may understood as, for example, sensor units which may be worn, or configured to be attached to, the feet of a user. Hence, the secondary sensor units may alternatively be referenced to as, for example, foot sensor units.

However, the primary and secondary sensor units are not limited to being held, worn, or configured to be attached to the hands or the feet, respectively, of a user. The primary and/or the secondary sensor units may be held worn, or configured to be attached to other parts of a user's body. For example, the primary and/or the secondary sensor units may be worn as a piece of clothing or gear. The piece of clothing may comprise, but is not limited to, for example, pants, a shirt, a jacket, gloves, shoes, a belt or a hat. The gear may comprise, but is not limited to, for example, a helmet, a sports article, a backpack, or a tool.

The present disclosure is based on the concept of improving the precision of determining the positions of sensors by combining, or fusing, measurements of IMUs and determined ultrasonic time-of-flights between the sensors. If only IMUs are used, the measurements of such sensor units would drift, which would result in a reduced precision of such sensor units. Further, such sensor units may require intermittent calibration in order to produce acceptable measurements, which may prevent a user from continuously using the sensor units. On the other primary, if only time-of-flight was used, such a system would not be able to, for example, determine that sensor units were moving if all of them were moving in the same direction, since time-of-flight only determines relative position. In other words, without IMUs, a fixed reference point is required. Thus, a system, according to the present disclosure, which uses both IMU measurements and ultrasonic time-of-flights may provide a higher continuity and/or precision, without requiring a fixed reference point, or phrased differently, while allowing for a (intermittently) moving reference point.

Further, the present disclosure is based on the concept of enabling the use of time-of-flight by sending the ultrasonic pulses during predetermined time windows, which greatly reduced the required bandwidth, i.e. reduces the amount of data that needs to be processed. Listening, i.e. recording, for an ultrasonic pulse will inevitably result in receiving noise, which may comprise, for example, echoes of previously sent ultrasonic pulses. Receiving noise may be computationally taxing for the system, and thereby only listening during the time windows may reduce the computational load for the system. If the system received too much data, it may not be able to precisely, i.e. accurately, determine the positions of the sensor units. Thus, utilizing time windows allows for the system to both measure movement via IMUs and to determine distances by using time-of-flight, which may increase the precision of the system.

Each primary sensor unit may comprise a transducer unit configured for ultrasonic transmission. Each secondary sensor unit may comprise a transducer unit configured for ultrasonic reception. The transducer unit of the first sensor unit of the two secondary sensor units may be further configured for ultrasonic transmission.

A time window of the time windows may begin at a corresponding transmit time of the transmit times. Thus, the secondary sensors may start listening for an ultrasonic pulse at the same time that the ultrasonic pulse is transmitted, i.e. at the transmit time. Thus, the time during which the secondary sensors are listening for an ultrasonic pulse is reduced, which may reduce the amount of received data, or noise, which may increase the precision of the determination of positions of the sensor units.

Each sensor unit may comprise a micro-controller unit, MCU, configured for radio communication. The primary sensor units and the secondary sensor units may be configured for time synchronisation via radio communication. The time synchronisation may comprise:
transmitting a synchronisation packet from the first sensor unit to the primary sensor units and a second sensor unit of the secondary sensor units, wherein the synchronisation packet comprises a master time reference,
in response to receiving the synchronisation packet, setting an internal clock of the receiving primary sensor unit or second sensor unit to the master time reference, and transmitting a synchronisation response to the first sensor unit,
in response to receiving a synchronisation response, determining that the primary sensor unit or the second sensor unit which transmitted said synchronisation response is time synchronised.

The sensor units may be configured to communicate with each other via radio communication. The radio communication may be via a proprietary radio protocol, PRP. The PRP may be operated at an open 2.4 GHz band, wherein the sensor units may be configured to identify, i.e. search for, an available radio channel through which they communicate. Communication via PRP may use relatively small (data) packets, which may be less than 32 bytes. Further, data transfer rate via PRP may be approximately 2 Mbps. Communication via PRP supports Listen Before Talk, LBT, Listen After Talk, LAT, directed packets, and broadcast.

By performing the time synchronisation via radio communication, rather than via ultrasonic pulses, the ultrasonic spectrum is left undisturbed. Thus, precision of the determined time-of-flights may not be affected by the radio packets.

Each MCU of the sensor units may comprise an internal clock. Internal clocks have a tendency to drift. If the internal clocks of the different sensor units drift with regards to each other, the determined time-of-flights may be incorrectly determined. By time synchronising the MCUs, the time difference between the MCUs, i.e. the difference in drift between the MCUs, may be reduced, or removed. Thus, the precision of the determined time-of-flights may be increased.

The first sensor unit and the other sensor units may be understood to be arranged in a master-slave relationship with regards to the time synchronisation, wherein the first sensor unit is configured to act as the master and the primary sensors units and the second sensor unit are configured to act as slaves.

The system may be for a virtual drum kit. The system may be configured to determine that a virtual percussion instrument of the virtual drum kit has been hit based on the determined positions of sensor unit. The system may be further configured to convert the determined virtual percussion instrument hits to Musical Instrument Digital Interface, MIDI, data.

The virtual drum kit may comprise a plurality of drums, snares, and/or hi-hats. In other words, the virtual drum kit may comprise a plurality of percussion instruments. Further, the virtual drum kit may comprise virtual pedals, which when hit translates to a hit of a kick drum of the virtual drum kit or to opening or closing of a snare drum.

Determining that a specific virtual percussion instrument has been hit may comprise determining that a sensor unit has measured a hit and determining which virtual percussion instrument that has been hit. Determining that a sensor unit has measured a hit may be determined by analysing a movement measured by the IMU of the sensor unit, by, for example, an accelerometer of the IMU. Determining which virtual percussion instrument that has been hit may be determined by using the determined positions, wherein the determined positions may be compared to positions of the virtual percussion instruments. Thus, when a hit by a sensor unit has been determined, the current determined position of the sensor unit may be compared to positions of the virtual percussion instruments to determine which virtual percussion instrument that was hit.

The system may know the musical characteristics of each virtual percussion instrument of the virtual drum kit. Additionally, the system may determine the sound that would be produced by a virtual percussion instrument when hit. The sound of a virtual percussion instrument hit may be different based on what portion of the virtual percussion instrument that was hit and how hard, i.e. fast, the virtual drum percussion instrument was hit. In other words, the system may be configured to determine the musical characteristics of a determined virtual percussion instrument hit. Determined hits may comprise, for example, the type of virtual percussion instrument that was hit, what portion of the virtual percussion instrument that was hit, at what an angle the virtual percussion instrument was hit, the level of force, i.e. speed, that the virtual percussion instrument was hit.

The system may be configured to transmit at least one of the determined hits and the MIDI data in real-time to an auxiliary device. In other words, the system may be configured to transmit the determined hits in real-time to an auxiliary device. Correspondingly, the system may be configured to transmit the MIDI data in real-time to an auxiliary device. The system may be configured to transmit at least one of the determined hits and the MIDI data in real-time to an auxiliary device via MIDI interface.

The auxiliary device may be, for example, a smartphone, a tablet, a computer, a speaker, a recording device, or another smart device. Thus, the system allows for real-time playback, and/or recording, of the determined virtual drum hits.

The main sensor unit may comprise an additional MCU configured for wireless communication with the auxiliary device via the MIDI interface. The additional MCU may be configured to transmit the MIDI data in real-time to the auxiliary device. By using a wireless communication the sensor units may be moved freely as they may not be limited by a cable connecting the system and the auxiliary device.

The additional MCU may be configured for Bluetooth and/or Bluetooth Low Energy, BLE, communication.

Bluetooth, or BLE, communication may be configured to operate at a different radio frequency than what may be used for the PRP communication, thereby avoiding congestion, which may improve the performance of the system. Bluetooth, or BLE, communication may be preferred for using MIDI.

The system may be configured for performing an environment characterization process, the environment characterization may comprise the steps of:
transmitting a characterisation ultrasonic pulse from a primary sensor unit,
recording during an echo time window by the secondary sensor units,
determining a time-of-flight of a recorded echo of the characterisation ultrasonic pulse recorded during the echo time window, and
determining an interval time between the transmit times such that the interval is different from any determined time-of-flight of a recorded echo.

The distance between sensor units, when used by a user, is generally less than 2 m. However, the distance between sensor units and objects, such as furniture, walls, floor or ceilings, in an environment may be greater than 2 m. Additionally, an echo travels back and forth, thereby further increasing the travel distance. Thus, an echo of a characterisation ultrasonic pulse, may travel a longer distance, which corresponds to a longer time-of-flight, than an ultrasonic pulse, which is used for determining a distance between two sensor units, before it is recorded.

The system may be configured to record more than one echo during an echo time window. Correspondingly, the system may be configured to determine more than one time-of-flight of recorded echoes of the characterisation ultrasonic pulse recorded during the echo time window.

A characterisation ultrasonic pulse may of course bounce more than once in an environment. Thus, an echo may recorded more than once, wherein the following recordings are due to the echo having bounced additional times, i.e. echoes of echoes. However, after each bounce the amplitude of the echo is reduced. The system may therefore be limited to only recording echoes which have an amplitude above a predetermined threshold.

The interval time may be greater than any recorded time-of-flight of a recorded echo. Thus, the system may be configured to wait until echoes produced by prior ultrasonic pulses have substantially disappeared, or that amplitudes of echoes produced by prior ultrasonic pulses have been reduced.

Alternatively, the interval time may be lesser than any recorded time-of-flight of a recorded echo. Thus, the system may be configured to record an ultrasonic pulse before echoes produced by a prior ultrasonic pulse reaches the sensor unit(s).

Receiving an echo of a ultrasonic pulse during a time window could be incorrectly interpreted as receiving another ultrasonic pulse. By recording echoes and determining interval times the system can avoid that an echo is incorrectly recorded by a sensor unit during a time window. Thus, false positives may be avoided, which may increase the precision of the system.

The system may be configured for performing a calibration. The calibration may comprise:
transmitting a first calibration ultrasonic pulse from the first sensor unit,
receiving the first calibration ultrasonic pulse by the second sensor units,
determining a time-of-flight of the first calibration ultrasonic pulse,
transmitting a second calibration ultrasonic pulse from each of the primary sensor units,
receiving the second calibration ultrasonic pulses by the secondary sensor units,
determining the time-of-flight of each of the calibration ultrasonic pulses to each of the secondary sensor units, and
determining distances between the sensor units based on the determined time-of-flights.

Thus, the system may know the distances between all of the sensor units. The determined distances may be utilized in order to increase the precision of determining the distance between sensor units when the system is being used by a user. For example, by knowing the distance from a primary sensor unit to two secondary sensor units, movement, determined via determined time-of-flights, of the primary sensor unit can be converted to a position of the primary sensor unit by using multi-lateration (i.e. using distances) the determined movements with regards to the two secondary sensor units. The determined distances between the sensor units may be recorded as reference distances.

The calibration may further comprise determining, by each IMU of the sensor units, a reference position. Thus, movement of a sensor comprising an IMU may be compared to the reference position, which may increase the precision of the system.

The calibration may comprise prompting a user of the system to place the sensor units according to a calibration configuration. The calibration configuration may comprise, for example, holding the primary sensor units in the user's hands, attaching, or mounting, the secondary sensor units on the user's feet. The calibration configuration may further comprise, for example, aiming the primary sensor units forward, and levelled, i.e. parallel, with the ground, and keeping the secondary sensor units still.

The second sensor unit may comprise a transducer unit comprising at least two transducer elements. The first calibration ultrasonic pulse may be received by each of the transducer elements. The calibration may further comprise the steps of:
determining a time-of-flight of the first calibration ultrasonic pulse for each of the transducer elements, and
determining the relative orientation and/or location of the secondary sensor units based on the determined time-of-flights of the first calibration pulse received by the transducer elements.

The first sensor unit may also comprise at least two transducer elements. The second sensor unit may be configured to transmit a second calibration ultrasonic pulse from a transducer element of the transducer element of the second sensor unit. The calibration process may further comprise determining a time-of-flight of the second calibration ultrasonic pulse for each of the transducer elements of the first sensor unit, and determining the relative orientation and/or location of the secondary sensor units based on the determined time-of-flights of the first calibration pulse and the second calibration pulse received by the transducer elements.

The transducer elements may be arranged in an asymmetric pattern. Thus, the distance between the transducer of elements of one of the secondary sensor units and the transducer element sending a first, or second, calibration pulse is different for each of the transducer elements, which may be recorded as different time-of-flights. The different distances, i.e. the different time-of-flights, may be used for determining the relative orientation and/or location of the secondary sensor units.

The system may be configured to determine the positions of the sensor units in real-time by using a digital filter. The digital filter may be fed with the measured movements and the determined distances.

The digital filter may be configured to use, i.e. be fed with, a series of determined movements and/or determined distances, which may comprise statistical noise and/or other inaccuracies, in order to produce estimates of unknown variables that tend to be more accurate than those based on a single measurement alone. The digital filter may be configured to estimate a joint probability distribution over the variables for each timeframe. The digital filter may be configured as a Kalman filter.

The system may be configured to use a second digital filter. The second digital filter may be configured to be fed with the movements measure by the IMUs of the sensor units. The filtered movement measurements may have an increased accuracy than the unfiltered movement measurements. The system may be configured to use the second digital filter to improve the accuracy of the movement measurements before determining the positions of the sensor units based on the measured movements and the determined distances.

A first sensor unit of the primary sensor units may further comprise a haptic feedback device. The haptic feedback may comprise, for example, vibration. The haptic feedback may comprise, for example, an eccentric rotating mass actuator, a linear resonant actuator, or a piezoelectric actuator. The haptic feedback device may be configured to haptically communicate messages to a user holding the primary sensor unit, wherein a message may comprise a haptic pulse or a haptic pulse pattern. For example, the haptic feedback device may be configured to transmit a haptic message to the user when the system turns on, turns off, or when a setting or configuration of the system has been changed.

It is noted that other embodiments using all possible combinations of features recited in the above described embodiments may be envisaged. Thus, the present disclosure also relates to all possible combinations of features mentioned herein.

### BRIEF DESCRIPTION OF DRAWINGS

Exemplifying embodiments will now be described in more detail, with reference to the following appended drawings:

FIG. 1 is a schematic illustration of a primary sensor unit and a secondary sensor unit, in accordance with some embodiments;

FIG. 2 is schematic illustration of a system, in accordance with some embodiments.

As illustrated in the figures, the sizes of the elements and regions may be exaggerated for illustrative purposes and, thus, are provided to illustrate the general structures of the embodiments. Like reference numerals refer to like elements throughout.

### DETAILED DESCRIPTION

Exemplifying embodiments will now be described more fully hereinafter with reference to the accompanying drawings in which currently preferred embodiments are shown. The present disclosure may, however, be embodied in many different forms and should not be construed as limited to the embodiments set forth herein; rather, these embodiments are provided for thoroughness and completeness, and fully convey the scope of the present disclosure to the skilled person.

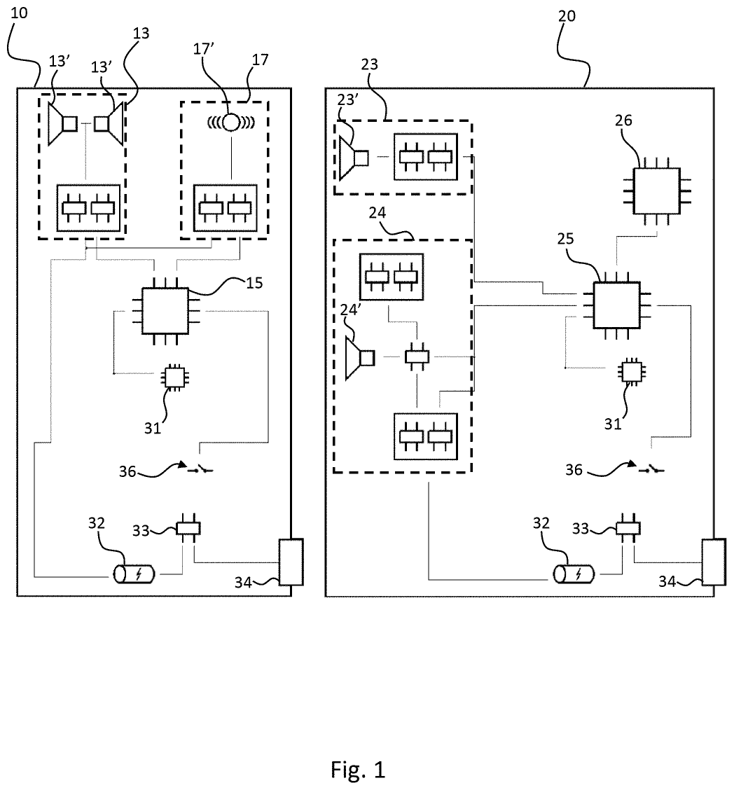

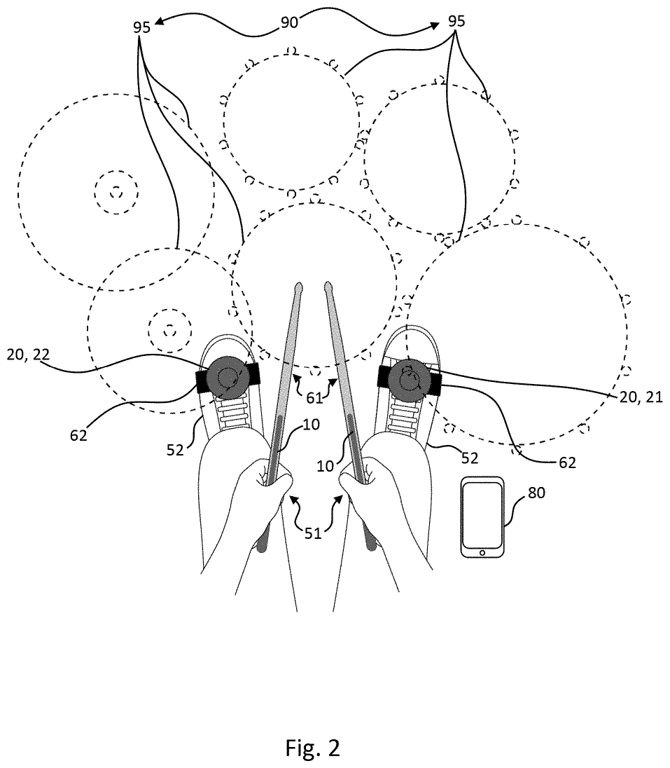

With reference to FIG. 1, a primary sensor unit 10 and a secondary sensor unit 20 of a system (not shown; see FIG. 2), in accordance with some embodiments, will be described. It is to be understood that the system may comprise more than one primary sensor unit 10 and/or more than one secondary sensor unit 20. For example, the system may comprise two primary sensor units 10 and two secondary sensor units 20.

The primary sensor unit 10 and the secondary sensor unit each comprise a micro-controller unit, MCU, 15, 25. The primary sensor unit 10 and the secondary sensor unit 20 may alternatively comprise a processor or a micro-processor, instead of an MCU 15, 25. The MCUs 15, 25 may be configured for radio communication.

The primary sensor unit 10 and the secondary sensor unit 20 each comprise an inertial measurement unit, IMU, 31. Each inertial measurement unit 31 may be configured to measure movement of the sensor unit 10, 20. Each IMU 31 is communicatively connected to the MCU 15, 25 of the sensor unit 10, 20.

The primary sensor unit 10 comprises a transducer unit 13. The transducer unit 13 is configured for ultrasonic transmission. The transducer unit 13 comprises two transducer elements 13′ and a driver circuit. The transducer elements 13′ are arranged in opposite directions. The transducer unit 13 is not limited to comprising two transducer elements 13′, and may comprise, for example, one, two, three, four, or more, transducer elements 13′. The transducer elements 13′ are connected to the MCU 15 via the driver circuit of the transducer unit 13.

The primary sensor unit 10 further comprises a haptic feedback device 17. The haptic feedback device 17 comprises an actuator 17′ configured to produce haptic feedback, such as vibration, and a driver circuit. The actuator 17′ is connected to the MCU via the driver circuit of the haptic feedback device 17. The present disclosure is not limited to a primary sensor unit 10 comprising a haptic feedback device 17. For example, a system, in accordance with some embodiments, may comprise two primary sensor units 10, wherein one, both, or none of the primary sensor units 10 comprises a haptic feedback device 17.

The secondary sensor unit 20 comprises two transducer units 23, 24. A first transducer unit 23 of the two transducer units 23, 24 is configured for ultrasonic transmission. The first transducer unit 23 comprises a transducer element 23′ and detector circuit. The transducer element 23′ is connected to the MCU 25 via the converter circuit of the first transducer unit 23. A second transducer unit 24 of the two transducer units 23, 24 is configured for ultrasonic transmission and for ultrasonic reception. The second transducer 24 further comprises a transducer element 24′, a switch, a detector circuit connected and a driver circuit. The detector unit and the driver circuit are configured to be connected to the transducer element 24′ via the switch. The second transducer unit 24 may be configured to be operated in an ultrasonic transmission configuration or in an ultrasonic reception configuration. In the ultrasonic transmission configuration, the switch may be arranged to connect the driver unit of the second transducer unit 24 to the transducer element 24′. Correspondingly, in the ultrasonic reception configuration, the switch may be arranged to connect the detector unit of the second transducer unit 24 to the transducer element 24′. The present disclosure is not limited to a secondary sensor unit 20 comprising two transducer units 23, 24, as illustrated in FIG. 1. For example, a second sensor unit 20 may comprise one or more first transducer units 23, and/or one or more second transducer units 24. Accordingly, a secondary sensor unit 20 may only comprise one or more first transducer units 23, or only one or more second transducer units 24.

The secondary sensor unit 20 further comprises a second MCU 26. The second MCU 26 is configured for wireless communication. The second MCU 26 is communicatively connected to the MCU 25. The system may comprise one secondary sensor unit 20 which comprises a second MCU 26. Thus, the present disclosure is not limited to a sensor unit 20 comprising a second MCU 26.

The primary sensor unit 10 and the secondary sensor unit 20 each comprise a rechargeable battery 32, a charger 33, and a charging connector 34. The battery 32 is connected to the charging connector 34 via the charger 33. The charging connector 34 is configured for connecting the corresponding sensor unit 10, 20 to an electrical energy source. The battery 32 is configured to provide the corresponding sensor unit 10, 20 with electrical energy. The battery 32 of the primary sensor unit 10 is electrically connected to the transducer unit 13, the haptic feedback unit 17 and the MCU 15. The battery 32 of the secondary sensor unit 20 is electrically connected to the first transducer unit 23, the second transducer unit, and the MCU 25. The present disclosure is not limited to sensor units 10, 20 comprising a rechargeable battery 32, a charger 33, and a charging connector 34, as shown in FIG. 1. For example, the sensor units 10, 20 may comprise replaceable batteries.

FIG. 2 is schematic illustration of a system 1 for a virtual drum kit 90, in accordance with some embodiments. FIG. 2 illustrates the system 1 when in use by a user. The perspective in FIG. 2 is from the eyes of the user.

It should be noted that present disclosure is not limited to a system 1 for a virtual drum kit 90. The present disclosure is provided to facilitate an increased understanding of the inventive concept. The system 1 may alternatively be for, for example, gaming, industrial applications, sports, and/or skills training.

The system 1 comprises two primary sensor units 10 and two secondary sensor units 20, 21, 22. Each primary sensor unit 10 is arranged inside a drum stick 61. The two drum sticks 61 are held in the user's hands 51.

A first sensor unit 21 of the two secondary sensor units 20 is arranged on the user's right foot 52. A second sensor unit 22 of the two secondary sensor units 20 is arranged on the user's left foot 52. The secondary sensor units 20, 21, 22 are arranged to the feet of the user by straps 62. The secondary sensor units 20, 21, 22 are arranged on the upper side of the user's feet 52.

FIG. 2 illustrates a virtual drum kit 90 comprising four virtual percussion instruments 95. The virtual drum kit 90 is shown with dashed lines to indicate that they are not physically present. Rather, the shown virtual drum kit 90 is (virtually) arranged at the shown location. The virtual drum kit 90 is not limited to the shown configuration of virtual percussion instruments 95. For example, the virtual drum kit 90 may comprise substantially any number of virtual percussion instruments 95, such as one, two, three, four, five, six, seven, eight, or more. Further, the virtual percussion instruments 95 are not limited to being virtual drums 95, as shown in FIG. 2. A virtual percussion instrument 95 may be configured as, for example, pedals, snares, hi-hats, bells, or any kind of percussion instrument.

Each sensor units 10, 20 comprises an IMU (not shown; see FIG. 1) configured to measure movement of the sensor unit 10, 20. The IMU may comprise an accelerometer and/or a gyroscope. The primary sensor units 10 and the second sensor unit 22 may be configured to send the measured movements to the first sensor unit 21 via radio communication. The sensor units 10, 20 may comprise an MCU (not shown; see FIG. 1) configured for radio communication. The measured movements may be sent, i.e. transmitted, by the MCUs. One or more MCU may be configured to apply a digital filter on the measured movements to produce filtered measured movements. For example, the MCUs of the primary sensor units 10 and the second sensor unit 22 may be configured to produce filtered measured movements and to send the filtered measured movements, via radio communication, to the first sensor unit 21. Alternatively, the primary sensor units 10 and the second sensor unit 22 may be configured to send the measured movements, via radio communication, to the first sensor unit 21. The MCU of the first sensor unit 21 may be configured to apply a digital filter to the measured movements received from the primary sensor units 10 and the second sensor unit 22.

Further, the primary sensor units 10 may be configured to buffer the measured movements before sending the measured movements to the first sensor unit 21. Thus, the required bandwidth may be reduced. The buffering of the measured movements may comprise sending first and last samples of the buffered measured movements. The first and last samples may be used to linearise the buffered measured movements, i.e. determining a line between the first and last samples of the buffered measured movements.

The IMUs of the primary sensor units 10 may be arranged within the drum sticks 61 such that they are arranged under the hand of a user holding the drum stick 61 in an ordinary fashion. Thus, the primary sensor units 10 may be arranged close to a pivot point of the drum stick 61 when the drum stick 61 is used. Thus, the acceleration of the IMU may be reduced or minimized, which may prevent the IMUs of the primary sensor units 10 from being maxed out when the primary sensor units 10 are used by a user.

Data recorded by the IMUs of the primary sensor units 10 may be processed, by the MCU of the corresponding primary sensor unit 10, through a gesture recognition filter. The gesture recognition filter may be configured to determine that a user has moved a primary sensor unit 10 in accordance with a predetermined gesture. Upon a determination that a predetermined gesture has been made, the system 1 may perform a number of actions, which may include, for example, switching the virtual drum kit 90, adding audio effects, start and stop recordings, or send preconfigured (MIDI) commands.

The IMUs of the primary sensor units 10 may be configured to determine the orientation of the drum stick 61 in which it is arranged. The orientation of a drum stick 61 may comprise a roll, a pitch, and/or yaw.

A primary sensor unit 10 of the system 1 may be configured to determine a hit. A primary sensor unit 10 may determine a hit if a determined pitch and determined yaw of the drum stick 61 are above a predetermined hit threshold. The predetermined hit threshold may be compared to the root of the squared sum of angular velocity of the pitch and yaw. Thus, the roll, measured by the IMU, of the drum stick 61 may be cancelled or disregarded when determining a hit.

Determining hits by the secondary sensor units 20 requires less precision than determining hits by the primary sensor units 10, as the secondary sensor units 20 are limited by the floor on which the feet 52 is resting on. An accelerometer of the IMU of a secondary sensor unit 20 may be used to determine the distance travelled by the secondary sensor unit 20. Further, the orientation of the secondary sensor unit 20 may be used to determine if toes or a heel of the foot 52 were used for the hit.

The primary sensor units 10 and the first sensor unit 21 are configured to transmit ultrasonic pulses at transmit times. The primary sensor units 10 and the first sensor unit 21 may each comprise a transducer unit (not shown; see FIG. 1) configured for ultrasonic transmission, wherein the ultrasonic pulses are transmitted by the transducer units. The secondary sensor 20 units are configured to receive the ultrasonic pulses during time windows. The secondary sensor units 20 may each comprise a transducer unit configured for ultrasonic reception, wherein the ultrasonic pulses are received by the transducer units. The first sensor unit 21 may comprise a transducer unit which may be configured for ultrasonic transmission and reception.

A time window of the time windows comprises a corresponding transmit time of the transmit times. The system 1 is configured to determine a time-of-flight of an ultrasonic pulse of the ultrasonic pulses transmitted at a transmit time of the transmit times based on when the ultrasonic pulse was received during the corresponding time window. Determining a time-of-flight of an ultrasonic pulse may be determined by comparing the transmit time of the ultrasonic pulse with the time when the ultrasonic pulse was received. The second sensor unit 22 may be configured to determine the time-of-flight of an ultrasonic pulse and to transmit the determined time-of-flight to the first sensor unit 21. Alternatively, the second sensor unit 22 may be configured to transmit the time when the ultrasonic pulse was received to the first sensor unit 21 which may then determine the time-of-flight of the ultrasonic pulse.

The system 1 is further configured to determine distances between the secondary sensor units 20, and between the secondary sensor units 20 and the primary sensor units 10, based on the determined time-of-flights between said sensor units 10, 20. The second sensor unit 22 may be configured to determine the distance from itself to the primary sensor units 22 based on the determined time-of-flights. Alternatively, the first sensor unit 21 may be configured to determine the distances between the sensor units 10, 20 based on the determined time-of-flights, wherein the first sensor unit 21 may receive time-of-flights determined by the second sensor unit 22. In other words, some of the determination of distances may be performed by the second sensor unit 22 which are then sent to the first sensor unit 21, or, alternatively, all of the determination of distances may be performed by the first sensor unit 21.

The system 1 is configured to determine the positions of the sensor units 10, 20 in real-time based on the measured movements and the determined distances. The first sensor unit 1 may be configured to determine the positions of the sensor units 10, 20 in real-time based on the measured movements and the determined distances.

The sensor units 10, 20 may be configured for time synchronisation via radio communication, which may ensure that the transmit times and the time windows are time synchronised, thereby increasing the precision of determining the time-of-flights, which may result in more precisely determined distances between the sensor units 10, 20.

The first sensor unit 21 may be configured as a time synchronisation master, and the other sensor units 10, 22 may be configured as time synchronisation slaves. The sensor units 10, 20 may each comprise an internal clock, wherein the internal clock of the first sensor unit 21 may be understood as a master clock, wherein the master clock may be considered to be correct.

The time synchronisation may be operating in super cycles. A super cycle period, Tₛᵤₚₑᵣ, may be, for example, 500 ms. At the beginning of a super cycle, the master clock may be reset to zero. The first sensor unit 21, i.e. the master 21, may transmit a synchronisation, SYN, packet, via radio communication, at the beginning of each super cycle. The SYN packet may contain an indication of the master time, T_{SYN}, and/or which other sensor units 10, 22, i.e. the slaves 10, 22, that may be unsynchronised, and/or if the first sensor unit 21 requests that any of the slaves 10, 22 should respond to the SYN packet.

Unsynchronised slaves 10, 22 may be constantly listening for the SYN packet. When the SYN packet is received by a slave 10, 22, the slave 10, 22 knows that the correct time, i.e. the time of the master clock, is equal to the master time, T_{SYN}, minus the time-of-flight of the SYN packet. The slave 10, 22 may respond to the SYN packet with an alive, ALV, packet if the slave was unsynchronised or if the master 21 requested a response. The slaves 10, 22 may be configured to transmit the ALV packet with a predetermined delay after receiving a SYN packet, in order to avoid that ALV packets from the slaves 10, 22 are transmitted at the same time. The master 21 may consider a slave 10, 22 to be synchronised if the slave 10, 22 responds to a SYN packet when requested.

When a slave 10, 22 receives a SYN packet, the slave 10, 22 may reset its internal clock, and may expect another SYN packet in Tₛᵤₚₑᵣ. A slave 10, 22 may expect another SYN packet in Tₛᵤₚₑᵣ*K_{drift}, wherein K_{drift} is the drift of the internal clock of the slave 10, 22. K_{drift} may be initially be equal to 1 for each slave. A slave 10, 22 may be configured to update K_{drift} by comparing its internal clock against the received master clock. Further, a the updating of K_{drift} may be fed through a (digital) low pass filter in order to avoid transient updates.

The sensor units 10, 20 may be configured to divide the super cycle, Tₛᵤₚₑᵣ, into a number of frames. The master 21 may be configured to transmit the number of frames to the slaves 10, 22. One of the primary sensor units 10 may be configured to transmit ultrasonic pulses at the beginning of every other frame, and the other primary sensor unit 10 may be configured to transmit the ultrasonic pulses at the beginning of the remaining frames. Thus, the sensor units 10, 20 may know when the sensor units 10, 20 are configured to transmit and receive ultrasonic pulses, which may reduce the required bandwidth. Thus, when the sensor units 10, 20 are time-synchronised, the secondary sensor units 20 may therefore only need to keep track of how many frames that have passed when an ultrasonic pulse is received in order to determine a time-of-flight of the ultrasonic pulse.

Thus, the system 1 may be configured to determine that a virtual percussion instrument 95 of the virtual drum kit 90 has been hit based on the determined positions of one sensor unit 10, 20, wherein the determined movements may be used to determine that a hit has been determined, or detected, and the determined distances may be used to determine which virtual percussion instrument 95 that has been hit.

The system 1 may be configured to convert determined virtual percussion instrument hits to Musical Instrument Digital Interface, MIDI, data. The MCU of the first sensor unit 1 may be configured to convert the determined virtual percussion instrument hits to MIDI data. The system 1 may be configured to transmit the determined hits and/or the MIDI data in real-time to an auxiliary device 80, wherein the determined hits and/or the MIDI data may be transmitted via a wireless interface, such as BLE. The auxiliary device 80 may be, for example, a smartphone, a tablet, a computer, a speaker, a recording device, or another smart device. The first sensor unit 21 may comprise a second MCU (not shown; see FIG. 1) configured for wireless communication with the auxiliary device 80. The additional MCU may be configured to transmit at least one of the determined hits and the MIDI data in real-time to the auxiliary device 80. However, the system 1 is not limited to transmitting the determined hits and/or the MIDI data to an auxiliary device 80 via a wireless interface. For example, the system 1 may be configured to transmit the determined hits and/or the MIDI data to the auxiliary device 80 via wire or cable.

The person skilled in the art realizes that the present invention by no means is limited to the preferred embodiments described above. On the contrary, many modifications and variations are possible within the scope of the appended claims.

Although features and elements are described above in particular combinations, each feature or element can be used alone without the other features and elements or in various combinations with or without other features and elements.

Additionally, variations to the disclosed embodiments can be understood and effected by the skilled person in practicing the claimed invention, from a study of the drawings, the disclosure, and the appended claims. In the claims, the word “comprising” does not exclude other elements, and the indefinite article “a” or “an” does not exclude a plurality. The mere fact that certain features are recited in mutually different dependent claims does not indicate that a combination of these features cannot be used to advantage.

1. A system for determining positions sensor units, comprising
two primary sensor units and two secondary sensor units, wherein each sensor unit comprises an inertial measurement unit, IMU, configured to measure movement of the sensor unit; wherein
the primary sensor units and a first sensor unit of the secondary sensor units are configured to transmit ultrasonic pulses at predetermined transmit times, wherein
the secondary sensor units are configured to receive the ultrasonic pulses during time windows, wherein a time window of the time windows comprises a corresponding transmit time of the predetermined transmit times, and wherein
the system is configured to determine a time-of-flight of an ultrasonic pulse of the ultrasonic pulses transmitted at a transmit time of the predetermined transmit times based on when the ultrasonic pulse was received during the corresponding time window; wherein
the system is further configured to determine a distance between two of the sensor units, based on the determined time-of-flight between said sensor units; and wherein
the system is configured to determine the positions of the sensor units in real-time based on the measured movements and the determined distances.

2. The system according to claim 1, wherein each primary sensor unit comprises a transducer unit configured for ultrasonic transmission; and wherein
each secondary sensor unit comprises a transducer unit configured for ultrasonic reception, wherein the transducer unit of the first sensor unit is further configured for ultrasonic transmission.

3. The system according to claim 1, wherein a time window of the time windows begins at a corresponding transmit time of the transmit times.

4. The system according claim 1, wherein each sensor unit comprises a micro-controller unit, MCU, configured for radio communication; and
wherein the primary sensor units and the secondary sensor units are configured for time synchronisation via radio communication,
wherein the time synchronisation comprises
transmitting a synchronisation packet from the first sensor unit to the primary sensor units and a second sensor unit of the secondary sensor units, wherein the synchronisation packet comprises a master time reference;
in response to receiving the synchronisation packet, setting an internal clock of the receiving primary sensor unit or the second sensor unit to the master time reference, and transmitting a synchronisation response to the first sensor unit; and
in response to receiving a synchronisation response, determining that the primary sensor unit or the second sensor unit which transmitted said synchronisation response is time synchronised.

5. The system according to claim 1, wherein the system is for a virtual drum kit and is further configured to determine that a virtual percussion instrument of the virtual drum kit has been hit based on the determined positions of one sensor unit.

6. The system according to claim 5, wherein the system is further configured to convert the determined virtual percussion instrument hits to Musical Instrument Digital Interface, MIDI, data.

7. The system according to claim 5, wherein the system is configured to transmit at least one of the determined hits and the MIDI data in real-time to an auxiliary device.

8. The system according to claim 7, wherein the first sensor unit further comprises a second MCU configured for wireless communication with the auxiliary device, and wherein the additional MCU is configured to transmit at least one of the determined hits and the MIDI data in real-time to the auxiliary device.

9. The system according to claim 1, wherein the system is further configured for performing an environment characterisation process comprising the steps of:
transmitting a characterisation ultrasonic pulse from a primary sensor unit;
recording during an echo time window by the secondary sensor units;
determining a time-of-flight of a recorded echo of the characterisation ultrasonic pulse recorded during the echo time window; and
determining an interval time between the predetermined transmit times such that the interval is different from any determined time-of-flight of a recorded echo.

10. The system according to claim 1, wherein the system is further configured for performing a calibration comprising:
transmitting a first calibration ultrasonic pulse from the first sensor unit;
receiving the first calibration ultrasonic pulse by a second sensor unit of the secondary sensor units;
determining a time-of-flight of the first calibration ultrasonic pulse;
transmitting a second calibration ultrasonic pulse from each of the primary sensor units;
receiving the second calibration ultrasonic pulses by the secondary sensor units;
determining the time-of-flight of each of the calibration ultrasonic pulses to each of the secondary sensor units; and
determining distances between the sensor units based on the determined time-of-flights.

11. The system according to claim 10, wherein the calibration further comprises determining, by each IMU of the sensor units, a reference position.

12. The system according to claim 10, wherein the second sensor unit comprises a transducer unit comprising at least two transducer elements, and
wherein the first calibration ultrasonic pulse is received by each of the transducer elements, and wherein
the calibration further comprises the steps of:
determining a time-of-flight of the first calibration ultrasonic pulse for each of the transducer elements, and
determining the relative orientation and/or location of the secondary sensor units based on the determined time-of-flights of the first calibration pulse received by the transducer elements.

13. The system according to claim 1, wherein the system is further configured to determine the positions of the sensor units in real-time by using a digital filter, wherein the digital filter is fed with the measured movements and the determined distances.

14. The system according to claim 1, wherein at least one primary sensor unit of the first sensor units further comprises a haptic feedback device.

15. A method for determining positions of sensor units of a system, wherein the system comprises two primary sensor units and two secondary sensor units, wherein each of the sensor units comprises an inertial measurement unit, IMU, configured to measure movement of the sensor unit, wherein the method comprises the steps of:
transmitting ultrasonic pulses at predetermined transmit times from a primary sensor unit of the primary sensor units and a first sensor unit of the secondary sensor units;
receiving the ultrasonic pulses by the secondary sensor units during time windows, wherein a time window of the time windows comprises a corresponding transmit time of the predetermined transmit times;
determining a time-of-flight of an ultrasonic pulse transmitted at a transmit time based on when the ultrasonic pulse was received during the corresponding time window; and
determining the positions of the sensor units in real-time based on the measured movements and the determined distances.
